(19) United States
(12) Patent Application Publication
(10) Pub. No.: US 2006/0123431 A1
(43) Pub. Date: Jun. 8, 2006

(54) Service logic program instance connection

(76) Inventors: Paul D. Schepers, Frisco, TX (US); Mark S. Evans, Plano, TX (US); Alan L. Gerhardt, Pittsburg, TX (US); Warner Lee Hines, Southlake, TX (US); Raymond M. Parker, Carrollton, TX (US); Robert L. Reeves, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/006,204

(22) Filed: Dec. 6, 2004

(51) Int. Cl. G06F 9/44

(52) U.S. Cl. 719/320

(57) ABSTRACT

Networks, methods, and devices are provided for SLP instance connection. One method embodiment includes managing SLP instances in a multi-SLEE. The method includes instantiating a first SLP to handle a session with a network based application. A second SLP is instantiated to handle an intelligent peripheral (IP) for use with the network based application. The method includes establishing a connection between the second SLP and the first SLP.

Intelligent networks (INs) are being used to provide an increasing number of services to communication networks. INs deliver these services to a number of wireline and wireless stations, e.g., a number of communications devices such as phones, PDA's, etc. The service functions that deliver the services to these stations can be separated from the equipment that is providing the switching functionality to the stations. One benefit of this separation is that network providers do not have to perform major modifications on multiple physical switches when a new service is introduced. For example, in a publicly switched telephone network (PSTN) a physical circuit based switch connects a call signal, or other media data traffic, on one media channel to another available media channel in order to continue routing the signal to the intended destination. INs can provide enhanced voice, video, and data services and dynamic routing capabilities by using a number of different program switches. In both INs and the PSTN, the actual voice call can be transmitted over a circuit-switched network, but the signaling, e.g., control signal transmission, can be accomplished by executing program instructions on a separate SS7 packet-switched network.

Signaling System 7 (“SS7”) is a well known dialogue-based communications protocol used for signaling and which may be used for communications with computing platforms such as telecommunications platforms, e.g., mobile switching center (MSC) gateways, service control gateways (SCGs), or other service capability server (SCS), etc., as the same are known and understood by one of ordinary skill in the art. The data exchanged between an originating switch and, for example, a SCG is commonly formatted into intelligent network application part (INAP) messages and communicated between these network elements using a transaction capabilities application part (TCAP) messages. INAP and TCAP are examples of protocol layers within the SS7 protocol architecture. At the end of the exchange of INAP messages the service control gateway directs the originating switch to connect the telephone call to a final destination in order to facilitate the transfer of a media stream, e.g., voice, data, and/or video, etc, over a media channel, e.g., DS0, T1, DS3, SONET, etc. Messages can be arranged in an octet format. Each octet represents a byte, or 8 bits of data, presented as a pair of hexadecimal values.

Service logic programs (SLPs) are used in telecommunication networks to handle sessions, e.g., message exchanges, between various requested services on a network. For example, SLPs can operate in a service logic execution environment (SLEE) to provide a service control function (SCF) within a network device, e.g., a service control point (SCP). As processor and memory capabilities have increased, it has become possible to facilitate multiple SLEEs (multi-SLEEs) on a given network device. The number of SLEEs in a multi-SLEE environment is associated with the amount of processing resources available, e.g., number of processors (CPUs), on a given network device. Each SLEE is generally assigned to a particular processor, however, multiple SLEEs can be assigned to one processor and the associated memory allocated to that particular processor.

SLPs are instantiated in a SLEE to execute instructions to perform various functions. Generally, the term “instance” refers to a running program, and is used in programming parlance to refer to a process running in user space. A process refers to a running program which has a state and may have an input and output. Each process has one or more threads. A thread is an executable set of instructions being executed on a processor. An SLP “instance” can also be referred to as a user level thread for a user level program, e.g., SLP as opposed to a kernel or operating system program. “To instantiate”, or “instantiating”, an SLP means creating or launching a particular SLP instance.

A SLP may be instantiated in a given SLEE to handle a session with a service application on the network. A different SLP may be instantiated to invoke and/or control the operation of another device on the network, e.g., an intelligent peripheral (IP) having a specialized resource function (SRF) (discussed below). Previously, in single SLEE environments, the SLP handling a session was also the same SLP responsible for invoking other network resources, e.g., SRFs, and as such was provided with control over the operations of such IPs. In more modern INs more of the session control has been allocated, or provided to, the network applications, e.g., Parlay applications, residing elsewhere on the network, and not with the SLP instance in the SLEE. Control instructions are exchanged with SLEE via network messages through an SCG and/or SCS, for example. Parlay web services are one of a development tool which can accommodate the development of next generation telecommunication network applications. Parlay services are not network equipment specific, and are not network specific where a particular capability is relevant to more than one type of network. A Parlay application, or other network application, can generate a call, e.g. has the capability to initiate a call session to a particular called number. In such cases a SRF may be used to collect the digits of the called number, etc.

In a multi-SLEE, different SLPs may be used for handling a session with a network application and for controlling a SRF. The different SLPs may even be in different SLEEs altogether. A SLP handling a session with a network application should be able to communicate with a SLP handling another network device associated with or being used by that network application. However, in situations where much of the session control instructions are provided to a network application located elsewhere in the network, one SLP may be instantiated to handle a session with a network application and another SLP be instantiated to control a requested SRF. In such cases, the SLP handling the session with the network application may not have a direct communication connection to a SLP controlling the SRF (also referred to as a “SRF SLP instance”) even though the SRF invoked on behalf of the network application. For example, when a network application requests a SRF, a first SLP handling the session with the network application can launch a new, second SLP, possibly in another SLEE, to invoke the SRF. In this scenario, the first SLP connected to the network application will not have control over the second SLP invoking the SRF. In this multi-SLEE environment the second SLP may not have any communication connection with the first SLP connected to the network application. Thus, messages exchanged between the network application and the SLP connected thereto are not communicated, or forwarded, to the SRF SLP instance.

### BRIEF DESCRIPTION OF THE DRAWINGS

FIG. 1 is a block diagram illustrating an exemplary communication network with which program embodiments can be implemented.

FIG. 2 illustrates block diagram example of mapping functional entities and physical elements within a network such as illustrated in FIG. 1.

FIG. 3 illustrate a multiple service logic execution environment (multi-SLEE) as can exist within a service control point in the above described networks and includes program embodiments.

FIG. 4 is a block diagram illustrating an operational embodiment of a SLEE having hardware and software such that program instructions can connect SLP instances according to embodiments of the invention.

### DETAILED DESCRIPTION

Embodiments of the present invention cover networks, methods, and devices, etc., for SLP instance (SLPi) connections. For example, a network device is provided including a processor coupled to a memory. Program instructions are provided, storable in the memory and executable by the processor, to instantiate a first SLP to handle a session with a Parlay application. The program instructions can execute to instantiate a second SLP to handle a specialized resource function (SRF) for use with the Parlay application. The program instructions are executable to forward a correlation ID from the first SLP to the second SLP and establish an inter-process communication (IPC) connection between the second SLP and the first SLP based on the correlation ID. Thus, in this embodiment, the program instructions are executable to receive Parlay application messages to the first SLP, forward the messages between the first SLP and the second SLP, terminate the second SLP when the a connection to the SRF is complete, and continue to execute the first SLP to continue handling the session with the Parlay application.

Method embodiments are provided for managing SLPis in a multiple service logic execution environment (multi-SLEE). One method embodiment for SLP instance connection includes instantiating a first SLP to handle a session with a network based application. A second SLP is instantiated to handle an intelligent peripheral (IP) for use with the network based application. The method includes establishing a communication connection between the second SLP and the first SLP such that messages exchanged between the network application and the first SLP can also be exchanged with the second SLP handling the IP dialog.

Example of Communications Network

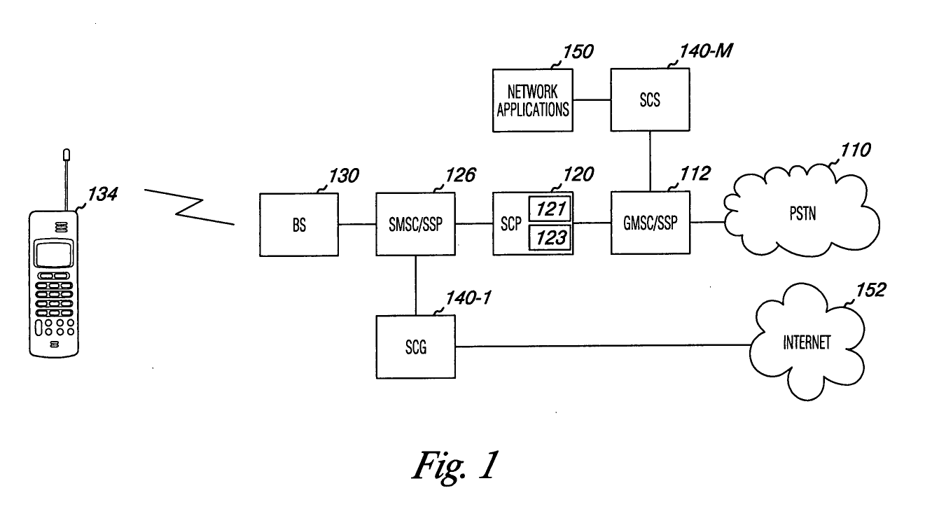

FIG. 1 illustrates one example of some of the physical components (also referred to as physical entities (PEs)) in a telecommunications network. In this example, a wireless telecommunications network is illustrated. Embodiments, however, are not limited to this example. Wireless telecommunications networks such as shown in FIG. 1 can be operated by an industry wireless provider or operator, e.g., Cingular, Vodafone, Verizon, Nextel, Sprint, and T-Mobile, etc. Such wireless networks can provide cellular/PCS (personal communication service) services like call origination and call delivery, streaming data, text messaging, etc., to a mobile device or handset 134.

Wireless networks 100 include one or more mobile switching centers (MSCs). For example, FIG. 1 illustrates a gateway MSC/service switching point (GMSC/SSP) 112 and a serving MSC/service switching point (SMSC/SSP) 126 (described in more detail below) which are connected to a base station (BS) 130. Base stations 130 are dispersed throughout the geographic area serviced by the network 100. Each MSC, e.g., 112 and 126, is responsible for establishing and maintaining calls between mobile devices and/or between a mobile device and a wireline device which is connected to the wireless network 100 from a local and/or long-distance, wireline/circuit-switched based network, e.g., the PSTN 110. Embodiments of the present invention can be utilized in wireless, wireline, or combination of wireline-wireless networks.

A MSC 112/126 is a telephone switch specialized for wireless and mobility support. A MSC 112/126 performs various functions, including mobility management, call handoffs, call admission, call control, resource allocation, and so forth. A call and/or other data can be relayed from the MSC 112/126 to base stations 130. This relay can be via a wireless communication interface to the mobile device 134 according to various interface protocol standards, e.g., according to an american national standards institute (ANSI), a global systems for mobile (GSM), or other standards interface, etc.

In the embodiment of FIG. 1, MSCs 112 and 126 are designated as a gateway MSC 112 (GMSC) and a serving MSC (SMSC) 126. This designation is provided to illustrate that a MSC can provide various functions. For example, a GMSC is used to receive an initial communication from a mobile device or from outside the given network (e.g., the PSTN 110 to the wireless network 100). A SMSC is used to provide the actual routing to a mobile device to which the communication is directed, i.e. the called number. In some cases, the GMSC and the SMSC can be provided by the same MSC.

As illustrated in the exemplary network of FIG. 1, an MSC, e.g., 112 and 126, can also serve as SSPs. A SSP directs requests for communication and/or application services (hereinafter “service request”) through the network 100. For example, a service request can be sent from a mobile device 134, or a service application located elsewhere on the network (e.g., a Parlay application). The SSP's function embodied within the GMSC 112 and SMSC 126 will execute program instructions to receive, process and appropriately route the service request, e.g., to another wireless/wireline and/or service application. When a service request is received, the SSP opens a dialogue with another media platform, e.g., SGS or SCS, and exchanges protocol messages embedded within SS7 protocol messages with the SCG or SCS.

A SCP 120 is used to handle the message exchange, e.g., session, between devices 134 and/or applications 150. That is, the SCP 120 can receive a service request from a mobile device 134 or wireline device (e.g., through the PSTN 110) via the GMSC 116 or SMSC 126. The SCP 120 can then instantiate a program, e.g., an SLP, to handle a subsequent message exchange with a service control gateway (SCG) 140-1 (shown connected to the Internet 152) and/or service capability server (SCS) 140-M (shown connected to other network applications 150), etc. Both SCG 1401-1 and SCS 140-M can serve as gateways as the same are known and understood in the art. The designator “M” is used to indicate that a given SCP 120 may handle message exchanges, or sessions, with a number of different network entities, whether SCSs or otherwise. That is, a SCG 140-1 and/or SCS 140-M can also provide access to other network functionality such as network service applications (e.g., web-based Parlay applications through the Internet 152), home location registers (HLRs), visiting location register (VLRs), etc. For example, a SCG 140-1 and/or SCS 140-M may be used to communicate a service request for a web service provided by a Parlay application. One of ordinary skill in the art will appreciate that a Parlay application, or other network application, can generate a call, e.g., has the capability to initiate a call session to a particular called number. More detail is not provided here so as not to obscure embodiments of the present application.

Parlay web services are one example of a development tool which can accommodate the development of next generation telecommunication network applications. Parlay services are not network equipment specific, and are not network specific where a particular capability is relevant to more than one type of network.

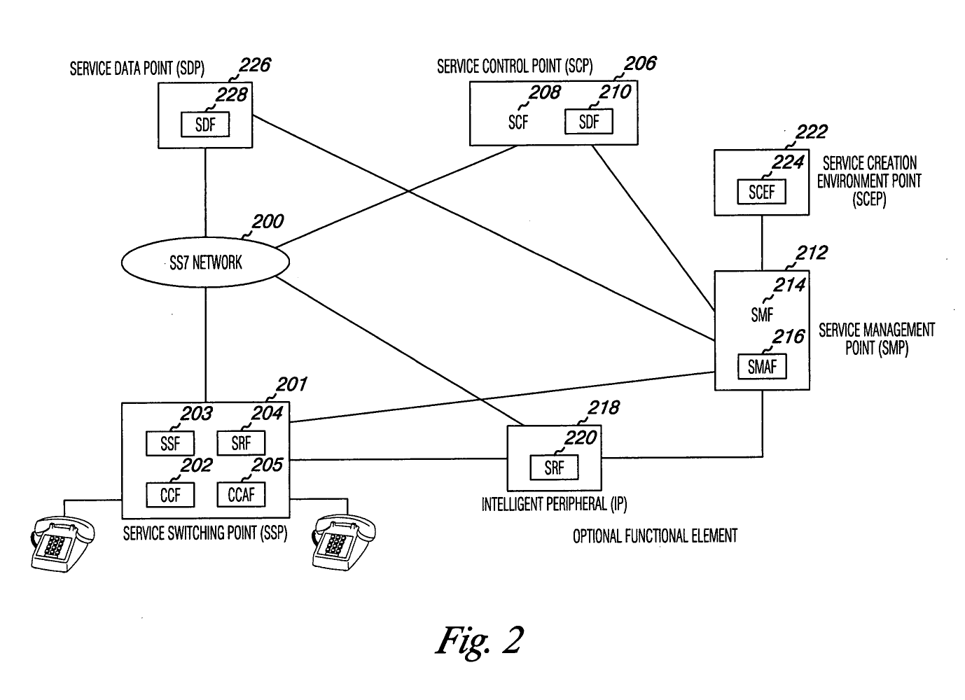

Embodiments of the invention include program instructions which can instantiate a first SLP in a SLEE to handle a session, e.g., message exchange, with a Parlay application. For example, a Parlay application may initiate a call session on a telecommunications network. While the first SLP will handle the message exchange, the control resides with the Parlay application. In this example, a call initiated by the Parlay application will further employ the use of a SRF (discussed more in connection with FIG. 2) to manage resources such as announcements, speech recognition, digit collection, protocol conversions, etc. According to embodiments, the program instructions can execute to instantiate a second SLP to control the operation, e.g. handle message exchange, with the SRF. As will be described in more detail below, program embodiments also execute instructions to establish a connection between the second SLP and the first SLP.

Each of the physical components of the network 100 can include access to processor and memory resources, as the same are known and understood in the art. Such memory resources can include SLPs executable by the processor resources in a SLEE to handle a message exchange with the Parlay application and can include SLPs executable to invoke a SRF. The network example of FIG. 1 illustrates the SCP 120 having access to such processor and memory resources. Embodiments, however, are not limited to the network illustration provided in FIG. 1.

Exemplary Mapping of Functional Entities to Physical Entities

Program instructions, e.g., computer executable instructions, within a network, can be broken down into particular functions (also referred to as functional entities (FEs)), associated with hardware including processor and memory resources, serving as SSPs and SCPs, as illustrated in FIG. 2. FIG. 2 provides an embodiment of a FE diagram which is useful to illustrate classes of functions as the same are understood in the telecommunications arts. The program instructions of the FEs serve as the software resources of intelligent nodes. As mentioned above, SS7 enables intelligent applications to communicate with other applications and to access databases located in various parts of the network.

The physical component of an SSP 201 provides stored program instruction control switches that interface to the SS7 signaling network 200. The SS7 network 200 includes signal transfer points (STPs) (not shown) as the same are known in the art. The SSP 201 includes software executable to perform a call control function (CCF) 202, and software executable to perform a service switching function (SSF) 203. The physical component of an SSP 201 can associate with the FEs of a CCF and SSF in a distributed manner, e.g., the software is distributed across multiple network computers such as in a local area network (LAN), a wide area network (WAN), and/or the Internet. Generally, a CCF includes executable instructions to control call processing and provides network connection services. An SSF includes executable instructions to support IN triggering during call processing and to access to IN functionality. The SSF recognizes IN service calls and routes the appropriate queries to a service control function (SCF) (discussed below) that resides in a SCP via the SS7 network through STPs.

The SSP 201 can also include software executable to perform a SRF 204 and software executable to perform a call control agent function (CCAF) 205. The SRF 204 includes executable instructions to support interaction between call processing software on the switch, e.g., SSP 201, and a SCF. The CCAF 205 includes executable instructions to support specialized network resources generally associated with caller interaction and to provide user access to the network.

The physical component of an SCP 206 provides stored program commands, e.g., computer executable instructions, which are interfaced to the STP nodes (not shown) within the SS7 signaling network 200. SCP commands are used by the SSP 201 to process calls. The SCP 206 is a fault-tolerant, high-capacity (as those terms will be recognized by one of ordinary skill in the art) transaction-processing entity that provides call-handling information in response to SSP 201 queries. The SCP 206 includes software executable to perform a SCF 208 and can include software executable to perform a service data function (SDF) 210. The SCF 208 includes instructions to execute IN service logic and influence call processing on the switch, e.g., SSP 201, via its interface to the SSF 204 through the SS7 network 200.

The physical component of a service management point (SMP) 212 provides operation, administration, and maintenance functions for the IN. The physical component of an SMP 212 includes the FEs of a service management function (SMF) 214 and a service management access function (SMAF) 216. The SMF 214 includes executable instructions to allow deployment and provision of IN services and to allow the support of ongoing operation. The SMAF 216 includes executable instructions to provide an interface between service managers and the SMF 214.

The physical component of an intelligent peripheral (IP) 218 generally includes software to perform a SRF 220, as mentioned above and described further below. The IP 218 can be connected to an SSP 201 over a high speed bus, e.g., a common object request broker architecture (CORBA) bus. The IP 218 uses the SRF 220 to provide enhanced services or functions, e.g., web enabled application services, such as those afforded through a Parlay application. The IP 218 can also employ a SRF 220 to manage resources such as announcements, speech recognition, digit collection, protocol conversions, etc. In other words, a SRF includes executable instructions to support specialized network resources generally associated with caller interaction with the IN. The SRF 220 starts a dialog, e.g., message exchange, under the control of an SCF 208 in the SCP 206. As discussed below, the SCF 208 can be implemented by SLPs executing in a SLEE. The SRF 220 is coupled to the SCP 206 through the SS7 network 200 and possibly relayed by an SSP 201.

The physical component of a service creation environment point (SCEP) 222 can include a service creation environment function (SCEF) 224. The SCEF includes executable instructions to allow services provided in the IN to be defined, developed, tested, and input to the SMF 214. The physical component of a service data point (SDP) 226 can include a service data function (SDF) 228, which includes instructions to manage customer and network data for real-time access by the SCF 208 in the execution of an IN service.

As noted above, TCAP is used to send database queries to a SCP 206. It is also used to send non-circuit related messages between switches, e.g., SSPs 201. TCAP keeps track of multiple queries that are part of the same session, e.g., message exchange associated with a call or service request. The INAP is used to define the operations required between IN network elements, such as SSPs 201 and SCPs 206. INAP protocols are used to initiate non-circuit related functions (e.g., not dealing with connect/disconnect) throughout the network 200. INAP protocols use TCAP to access remote devices.

In summary, FIG. 2 illustrates that each functional entity is mapped to a particular physical entity with a given network. Information flows between the functional entities are implemented in the physical entities through the appropriate INAP. Thousands and even tens of thousands of sessions, e.g., message exchanges, associated with a call or service request may be occurring concurrently in a given network.

Example of Multi-SLEE Including Program Embodiments

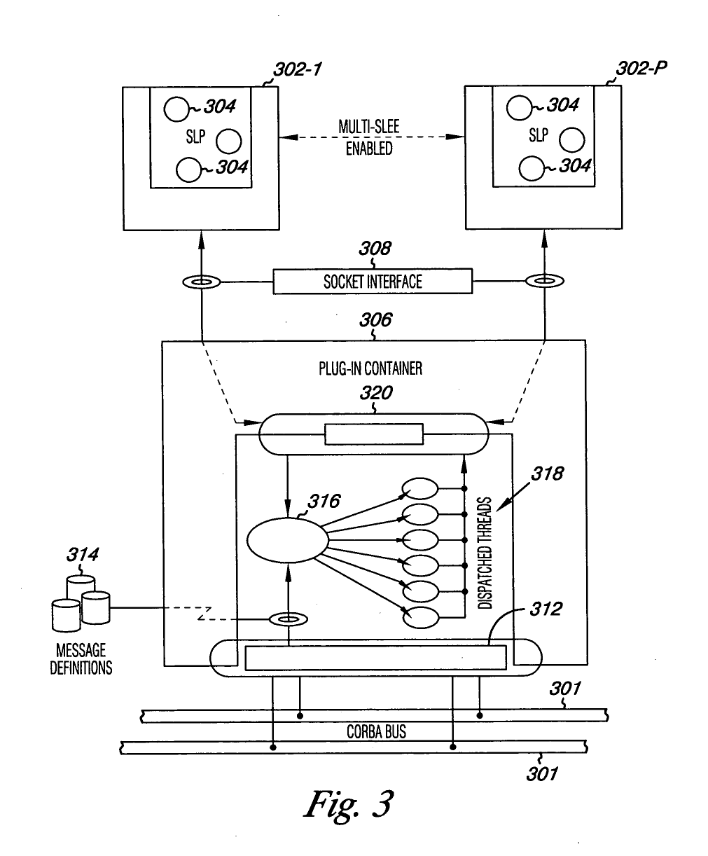

FIG. 3 illustrates a plug-in container 306 connecting a network signal path 301 to one or more service logic execution environments (SLEEs), illustrated as 302-1, . . . , 302-P. For example, the network signal path can include a high speed bus 301, e.g., a CORBA bus. The network signal path 301 can provide a connection between user space network applications, e.g., network-enabled applications such as a web-based Parlay application, and the SLEEs, 302-1, . . . , 302-P via the plug in container 306.

The plug-in container 306 and SLEE can be provided as part of a service control function (SCF) in a SCP and/or as part of a SCG or SCS as shown in FIG. 1. Embodiments, however, are not limited to these examples. The designator “P” is intended to indicate that embodiments are not limited to a particular number of SLEEs and can include a multi-SLEE environment.

Instances of one or more SLPs 304 can be created and executed within a SLEE (e.g., in response to a service request received to an SCP, SCS, SCG, etc., from a SSP as shown in FIG. 1) in order to handle message exchanges between various network applications and devices (also shown in FIG. 1). That is, each SLEE can have multiple instances of SLPs 304 at a particular point in time. Various network applications and/or devices can connect via the signal path 301 to exchange messages with the plug-in container 306. As illustrated in the example the multiple SLEEs, 302-1, . . . , 302-P, can connect to the plug-in container 306 via a socket interface 308 as the same are known and understood by one of ordinary skill in the art. As certain messages are received, e.g., for a call connection and/or service, program instructions execute to instantiate and SLP to handle the message exchange. As service requests and messages are exchanged between the plug-in container 306 and the network signal path, or bus, 301 they are handled by an external component interface 312 (as the same is known and understood) provided to the plug-in container 306. Program instructions can execute in connection with the external component interface 312 to retrieve message definitions from a message database 314 and provide the same to a plug-in dispatcher 316. The plug-in dispatcher 316 (discussed below) includes logic control for the execution of various processes and their associated threads.

According to embodiments of the present invention, a dispatcher program 316 is provided to the plug-in container 306. The dispatcher program 316 includes instructions which can execute to identify the signal's source, e.g., from a particular network application and/or device. For example, point code is a SS7 address of a network component, used to identify the signaling point in SS7 messages. Point code typically includes location information such as a network identifier. The point code or signaling source information may be extracted from a TCAP message or via other techniques as the same are known and understood in the art. As noted above, TCAP is the layer within the SS7 protocol that is used to communicate between IN elements, e.g., switching points/centers, control points, end points, etc. That is, TCAP protocol is used to communicate messages between different entities such as databases and end stations. For example, TCAP messages are typically used for communication between SSPs and SCPs within a communication network or between networks. The TCAP and/or other layer in the SS7 architecture contain “called number” information and/or “session type”. One of ordinary skill in the art will appreciate the manner in which program instructions can execute to identify and extract a called number (or portion thereof) and/or a session type from a TCAP and/or other SS7 layer message, e.g., a called number may be extracted from a MAP message. More detail is not provided here so as not to obscure embodiments of the present invention.

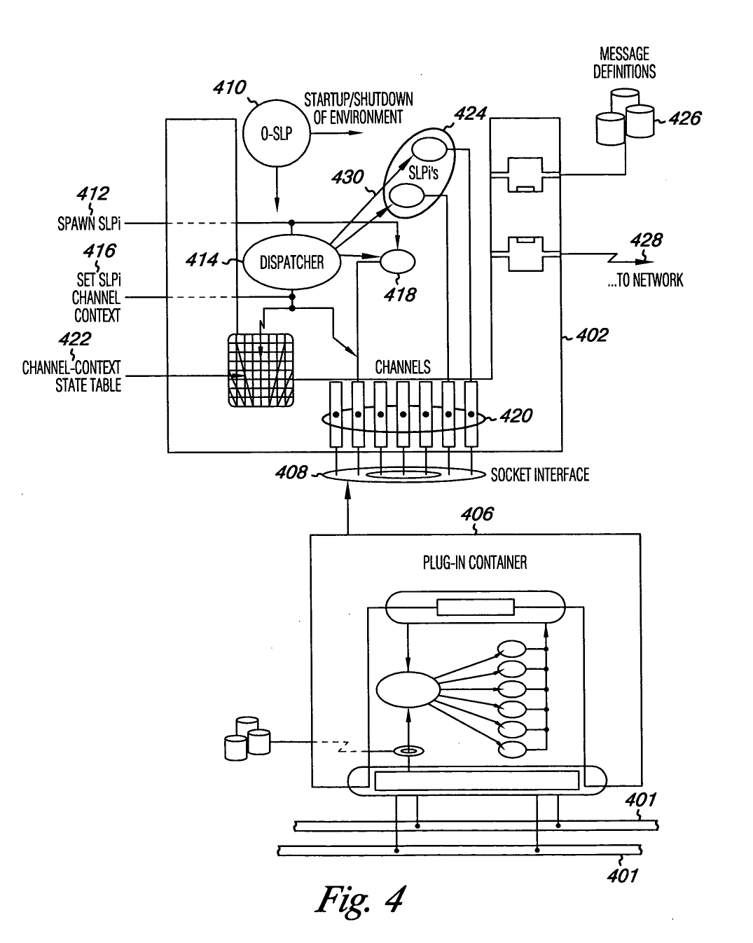

FIG. 3 illustrates the dispatcher program 316 executing instructions to dispatch a number of threads 318 which will be used by the SLEE to instantiate protocol specific SLPs 304 in the SLEEs, 302-1, . . . , 302-P. In FIG. 3, the dispatched threads 318 are exchanged with the SLEEs, 302-1, . . . , 302-P, through an application program interface (API) 320 and via a socket interface 308 (as the same are both appreciated by one of ordinary skill in the art), to instantiate various SLPs 304. Thus, as one example, program instructions can execute to launch a SLP to handle a session with a Parlay application, based on using the above described point code information or other suitable message identifier. As discussed in more detail with FIG. 4, the plug-in's API 320 and socket interface can provide a mechanism, such as an inter process communication (IPC) channel to connect SLPs in different SLEEs.

The various SLPs 304 within the SLEEs, 302-1, . . . , 302-P, provide connection information, message exchanges, etc., for accessing user space network applications, such as the web-based Parlay application in the example above, which are located elsewhere in a network and coupled to the SLEEs, 302-1, . . . , 302-P, via the bus 301 and the plug-in container 306. The application logic, e.g., control, for these other network applications is generally not contained in the SLEEs, 302-1, . . . , 302-P. The SLPs 304 in the SLEEs, 302-1, . . . , 302-P, however, do provide the connection information, and session handling (e.g., exchange messages for calls and services) as part of the SCF to access the application logic for user applications wherever they may be located in the network. Various SLPs 304 may also be used to handle operations with IPs. In other words, certain SLPs 304 can be written by a program developer, stored in memory, and executed as part of a SLEE, to handle network application sessions. Further, other SLPs 304 can be written by a program developer, stored in memory, and executed as part of a SLEE for invoking a SRF or other network function, as the same have been described in connection with FIG. 2. SLPs 304 can instantiate other SLPs.

Operational Embodiments of a SLEE having SLP Instances Connected

FIG. 4 is a block diagram illustrating an operational embodiment of a SLEE 402, within a multi-SLEE environment such as that illustrated in FIG. 3. The SLEE 402 includes program embodiments which execute to establish a communication connection between a SLP handling a session with a network based application and a SLP controlling an IP, e.g., having a SRF, for use with the network based application. The program embodiments are storable in memory and executable by a processor associated with a particular SLEE within a multi-SLEE environment. In the embodiment of FIG. 4, the SLEE 402 can be connected to a high speed bus 401 (e.g., for access to other user applications, or programs) in a communications network through a plug-in container 406 via a socket interface 408 as the same have been described above in connection with FIG. 3.

An operational service logic program (O-SLP) 410 can execute instructions to startup and shutdown the SLEE 402 environment. The SLEE 402 can receive instructions to spawn, e.g., create other SLPis as illustrated at 412. Upon startup, the O-SLP will create a SLEE dispatcher 414 which itself is an SLP. When an SLP instance begins 412 it communicates with the dispatcher SLP 414. SLPs can instantiate other SLPs, e.g., 418 and 424 as shown by arrows 430. By way of example, and not by way of limitation, a SLP handling a network application may receive a message that a network application wants the use of another network component, e.g., an IP having a SRF. As mentioned above, a SRF includes executable instructions to support specialized network resources generally associated with caller interaction with the IN and can also manage resources such as announcements, speech recognition, digit collection, protocol conversions, etc. In such an example, a first SLP handling a session with the network application will execute instructions to instantiate a second SLP to invoke the SRF and to control the operation thereof through a message exchange between the second SLP and the SRF. In the case of a network application session (e.g., where the control logic is with the network application itself and not with the first SLP which instantiated the second SLP to invoke the SRF) the network application will want to communicate with the SLP instance having control of the SRF, e.g., in this example the second SLP.

To achieve the same, program embodiments of the present invention are provided to the SLEE (e.g., storable in memory and executable by a processor as shown in FIG. 1) which execute to establish a connection between the second SLP (e.g., the SLP handling the message exchange with the SRF) and the first SLP (e.g., the SLP handling the message exchange with the network application). By way of example, and not by way of limitation, when a Parlay application sends a message to the first SLP requesting a SRF connection, program instructions execute to create a correlation ID in association with the first SLP instantiating the second SLP to invoke the SRF.

Program embodiments, provided to the SLEE, execute instructions to construct a correlation ID as a variable length bit string implemented in one or more octets to identify a particular SLEE and a particular SLP. As mentioned above, an octet represents a byte, or 8 bits of data, presented as a pair of hexadecimal values. Each hexadecimal value can represent a numerical value. The part of the variable length bit string representative of a particular SLEE can be composed of a numerical identifier value assigned to a particular SLEE when the SLEE was created by the O-SLP in the multi-SLEE environment. This numerical identifier value can be stored in memory associated with the SLEE in a look up table, as the same are known, and can be accessed by executing program instructions. Further, the part of the variable length bit string representative of the particular SLP instance in that SLEE that invoked the SRF can be composed of a numerical identifier value assigned to each SLP instance which instantiates another SLP within the SLEE to invoke a SRF. When a SLP instance is created in the SLEE to invoke a SRF (e.g., a first SLP instantiating a second to invoke a SRF), the program instructions can execute to combine the two above described values as a unique correlation ID and save the same to memory associated with the particular SLEE.

According to various embodiments, program instructions additionally execute instructions such that when one SLP instantiates another SLP instance to invoke a SRF, the correlation ID, as described above, is transmitted to the SRF in part with invoking the SRF. Instructions are provided in connection with invoking the SRF instructing the SRF to return the correlation ID in a message back to the multi-SLEE. That is, program embodiments execute to instruct the SRF that once the SRF begins a SRF dialog it is to return the correlation ID in a message to the multi-SLEE. That is, as part of a SRF dialog messages are exchanged with a dispatcher in a SLEE environment providing a service control function (SCF) in association with a service control point (SCP) in the above described networks. Correlation IDs are first received by a plug-in container 406 associated with the multi-SLEE as part of a SCG or SCS as described above in connection with FIG. 3. The plug-in container 406 includes a plug-in dispatcher such as dispatcher 316 illustrated in FIG. 3. When a correlation ID is returned to a plug-in dispatcher, the plug-in dispatcher executes instructions to create an inter process communication (IPC) connection through use of a plug-in API and socket interface (e.g., 320 and 302 in FIG. 3).

The example embodiment of FIG. 4 illustrates the plug-in container 406 (and its associated plug-in dispatcher) communicating with a SLEE in a multi-SLEE environment via socket interface 408. The SLEE dispatcher 414 provides control logic, e.g., as program instructions stored in SLEE memory and executable by the processor to which the SLEE is assigned, in order to set SLPi channel context 416 using a channel context state table 422 for each SLP in the SLEE. In other words, SLP instances (SLPis), e.g., 418, 424, etc., will be assigned a channel (e.g., a DS0 as the same will be appreciated in telecommunications parlance), shown generally as 420, to communicate with the socket interface 408.

By communicating with the channel context state table 422, the dispatcher 414 can additionally identify which SLP instances, for example, SLPis 424 and 418, have been assigned to which particular channels 420. The dispatcher in the plug-in container 406 and the SLEE dispatcher 414 both execute instruction to communicate and exchange information. The SLEE dispatcher 414 can receive and process a request to establish a connection between a first SLP handling a session with a network application and a second SLP controlling a SRF being used for that application based on the information returned in the correlation ID. The socket interface 408 will execute instructions to use a given channel 420 for an appropriate SLP instance identified by the SLEE dispatcher 414, e.g., to connect with the first SLP. That is, the socket interface will receive instructions from the SLEE dispatcher 414 and will execute instructions to use a given channel 420 as an IPC between a first SLP handling a session with a network application and a second SLP controlling a SRF being used for that application.

According to the various embodiments, program instructions execute using the plug-in dispatcher (e.g., dispatcher 316 in FIG. 3), which received the return SRF message, in cooperation with SLEE dispatcher 414 to identify the first SLP which instantiated the second SLP to invoke the SRF. This identification, in reference to the correlation ID in the return message, will also reveal the channel 420 associated with given SLP handling the session with the network application (for reference “first SLP”) in order to provide the IPC connection between the SFR SLP instance (for reference “second SLP”) and the first SLP. Once the IPC connection is formed between the first and the second SLPs subsequent messages received by the first SLP from the network application can be forwarded to the second SLP. As such control instructions from the network application can be passed to the second SLP. Additionally, when an IP connection is complete (e.g., the network application is through with a particular SRF) program instructions can execute to terminate the second SLP while maintaining the first SLP connected to the network based application.

As shown in FIG. 4, the SLEE 402 includes connections to other databases 426, e.g., for message definitions or otherwise, such as a SDP having a SDF, as the same have been described above in connection with FIG. 2. A given SLEE 402 can also include other connections to the network 428, e.g., for connections to SSPs having SSFs, SRFs, CCFs, etc., as the same have been described above in connection with FIG. 2. The other network entities (such as those shown in FIG. 2) can include IPs including SRFs to provide enhanced services or functions for a Parlay application via the program embodiments described herein. The program embodiments described herein establish the communication between the SLP which is connected to a particular network application and an SLP that is controlling an IP on behalf of the particular network application. A first SLP handling a given network application can receive and forward information between the network application and a second SLP, e.g., SRF SLP instance. The communication is asynchronous, i.e. channeled through first SLP, for the duration of the SRF connection, e.g. for as long as the SRF is being used by the network application. Upon completion of a SRF connection, the second SLP instance can terminate, leaving the first SLP to continue on.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for managing service logic program (SLP) instances in a multiple service logic execution environment (multi-SLEE), comprising:
instantiating a first SLP to handle a session with a network based application;
instantiating a second SLP to handle an intelligent peripheral (IP) for use with the network based application; and
establishing a connection between the second SLP and the first SLP.

2. The method of claim 1, wherein the method includes using the first SLP to instantiate the second SLP.

3. The method of claim 2, wherein the method includes forwarding a correlation ID from the first SLP to the second SLP.

4. The method of claim 3, wherein the method includes establishing the connection between the second SLP and the first SLP via an inter-process communication (IPC) connection based on the correlation ID.

5. The method of claim 1, wherein the method includes communicating asynchronously between the second SLP and the first SLP.

6. The method of claim 1, wherein the method includes terminating the second SLP upon completing use of the IP while maintaining the first SLP to continue handling the session with the network based application.

7. The method of claim 1, wherein the method includes receiving network based application messages to the first SLP and forwarding the messages between the network based application and the second SLP.

8. The method of claim 1, wherein the method includes instantiating the first SLP to handle a session with a Parlay application.

9. The method of claim 8, wherein the method includes instantiating the second SLP to invoke a specialized resource function (SRF).

10. A method for managing service logic program (SLP) instances, comprising:
within a multiple service logic execution environment (multi-SLEE), communicating between an SLP connected to a network based application and an SLP handling an intelligent peripheral (IP) invoked in association with the network based application;
when an IP connection is complete, terminating the SLP handling the IP while maintaining the SLP connected to the network based application.

11. The method of claim 10, wherein the method includes instantiating the SLP handling the IP based on a message received by the SLP connected to the network based application.

12. The method of claim 10, wherein the method includes communicating between an SLP connected to a Parlay application and an SLP controlling a specialized resource function (SRF).

13. The method of claim 12, wherein the method includes forwarding a correlation ID associated with the SLP connected to the Parlay application to the SLP controlling the SRF.

14. The method of claim 13, wherein the method includes establishing an inter-process communication (IPC) from the SLP controlling the SRF back to the SLP connected to the Parlay application based on the correlation ID.

15. The method of claim 14, wherein the method includes asynchronously communicating between the SLP controlling the SRF and the SLP connected to the Parlay application for a duration of the SRF connection.

16. A computer readable medium having a program to cause a device to perform a method, comprising:
instantiating a first SLP to handle a session with a network based application;
instantiating a second SLP to handle a specialized resource function (SRF) for use with the network based application; and
establishing a connection between the second SLP and the first SLP.

17. The medium of claim 16, wherein the method includes instantiating the first SLP to handle a session with a Parlay application and using the first SLP to instantiate the second SLP based on a message received to the first SLP.

18. The medium of claim 17, wherein the method includes instantiating the first and the second SLP in a multiple service logic execution environment (multi-SLEE).

19. The medium of claim 18, wherein the method includes forwarding a correlation ID from the first SLP to the second SLP.

20. The medium of claim 19, wherein the method includes establishing the connection between the second SLP and the first SLP via an inter-process communication (IPC) connection based on the correlation ID.

21. The medium of claim 20, wherein the method includes:
communicating asynchronously between the second SLP and the first SLP;
terminating the second SLP when a connection to the SRF is complete; and
continuing to execute the first SLP to continue handling the session with the network based application.

22. A service control point (SCP) in a communication network, the SCP having access to a processor and a memory to provide a multiple service logic execution environment (multi-SLEE), the multi-SLEE including program instructions storable in the memory and executable by the processor to:
instantiate a first SLP to handle a session with a Parlay application;
instantiate a second SLP to handle a specialized resource function (SRF) for use with the Parlay application; and
establish a connection between the second SLP and the first SLP.

23. The SCP of claim 22, wherein the program instructions are executable to forward a correlation ID from the first SLP to the second SLP.

24. The SCP of claim 23, wherein the program instructions are executable to establish an inter-process communication (IPC) connection between the second SLP and the first SLP based on the correlation ID.

25. The SCP of claim 24, wherein the program instructions are executable to:
receive Parlay application messages to the first SLP;
forward the Parlay application messages between the first SLP and the second SLP.
terminate the second SLP when the a connection to the SRF is complete; and
continue to execute the first SLP to continue handling the session with the Parlay application.

26. A communication network, comprising:
a service switching point (SSP);
a signal transfer point (STP) coupled to the SSP; and
a service control point (SCP) coupled to the STP, wherein the SCP includes access to a processor and a memory to provide a multiple service logic execution environment (multi-SLEE), the multi-SLEE including program instructions storable in the memory and executable by the processor to:
instantiate a first SLP to handle a session with a Parlay application;
instantiate a second SLP to handle a specialized resource function (SRF) based on a message received from the Parlay application to the first SLP;
forward a correlation ID from the first SLP to the second SLP; and
establish an inter-process communication (IPC) connection between the second SLP and the first SLP based on the correlation ID.

27. The network of claim 26, wherein the program instructions are executable to:
communicate Parlay messages asynchronously between the first SLP and the second SLP;
terminate the second SLP when the a connection to the SRF is complete; and
continue to execute the first SLP to continue handling the session with the Parlay application.

28. A network device having access to a processor and a memory, comprising:
a first service logic program (SLP) storable in the memory and executable by the processor to handle a session with a network based application;
a second SLP storable in the memory and executable by the processor to handle an intelligent peripheral (IP) for use with the network based application; and
means for establishing a communication between the second SLP and the first SLP within a multiple service logic execution environment.

29. The device of claim 28, wherein the IP includes a specialized resource function (SRF).

30. The device of claim 28, wherein the network based application is a Parlay application.

31. The device of claim 28, wherein the means includes program instructions executable to:
instantiate the second SLP based on a message received by the first SLP;
forward a correlation ID from first SLP to the second SLP; and
establish an inter-process communication (IPC) connection between the second SLP and the first SLP based on the correlation ID.
